(19) United States
(12) Patent Application Publication
(10) Pub. No.: US 2012/0191223 A1
(43) Pub. Date: Jul. 26, 2012

(54) SYSTEM AND METHOD FOR AUTOMATICALLY SELECTING SENSORS

(75) Inventors: Pallavi Dharwada, Minneapolis, MN (US); Jason Laberge, New Brighton, MN (US)

(73) Assignee: Honeywell International Inc., Morristown, NJ (US)

(21) Appl. No.: 13/013,247

(22) Filed: Jan. 25, 2011

(51) Int. Cl. G05B 15/02

(52) U.S. Cl. 700/17

(57) ABSTRACT

A system is configured to receive into a computer processor one or more of a map or model of an area monitored by one or more sensors, and display on a display unit a location and orientation of the one or more sensors in the monitored area. The system further is configured to receive into the computer processor, via contacting the display unit, a region or path within the monitored area. The computer processor orients the one or more sensors towards the path or region in response to the contacting of the display unit, and after the orienting of the one or more sensors, the monitored area is displayed on the display unit.

### TECHNICAL FIELD

The present disclosure relates to a system and method for automatically selecting sensors.

### BACKGROUND

Monitoring large and complex environments is a challenging task for security personnel because situations evolve quickly, information is distributed across multiple screens and systems, uncertainty is rampant, decisions can have a high risk and far reaching consequences, and responses must be quick and coordinated when problems occur. In most systems, security monitoring by operators occurs primarily using a series of sensor devices, such as video cameras. Many current systems rely on a live camera feed to provide information to users about the camera's viewable range. In addition, current camera monitoring systems are limited to mouse and keyboard input from a single person which is error prone and slow.

### BRIEF DESCRIPTION OF THE DRAWINGS

FIG. 1 illustrates an output on a display unit of locations and orientations of camera icons.

FIG. 2 illustrates an output on a display unit of a user selecting a region to be monitored by one or more cameras.

FIG. 3 illustrates an output on a display unit of an orientation of one or more cameras towards the region selected in FIG. 2.

FIG. 4 illustrates an output on a display unit of thumbnail views of one or more cameras.

FIG. 5 illustrates an output on a display unit of a user selecting a path to be monitored by one or more cameras.

FIG. 6 illustrates an output on a display unit of an orientation of one or more cameras towards the region selected in FIG. 5.

FIG. 7 illustrates a flowchart of an example process to automatically orient one or more sensors via a contacting of a touch sensitive output device.

FIG. 8 is a block diagram of a computer system upon which one or more embodiments of the current disclosure can operate.

### DETAILED DESCRIPTION

One or more embodiments of this disclosure relate to the use of a touch sensitive system and intuitive gestures to support camera selection in a monitoring or surveillance environment, which can improve operator situation awareness and response. While this disclosure focuses on the use of cameras, other sensing devices such as infrared sensors, radar sensors, and millimeter wave sensors (MMW) could be used. These embodiments are characterized by one or more of the following features. First, gestures are used to specify a region of interest based on which the system automatically selects the cameras that cover the region selected. Second, gestures are used to specify a path of interest based on which the system will automatically select the sequence of cameras that cover the path specified. Third, operators can specify the region or path using direct gestures, and these operators are not required to memorize asset IDs and/or camera numbers or names in order to select them. Fourth, gestures are used to select cameras in the context of the current environment. Fifth, building maps (two dimensional) or models (three dimensional) show critical information about the environment, define the relationship between camera locations and regions of interest, and provide an important context for security monitoring. Sixth, selected cameras automatically orient (pan, tilt, zoom) to the region of interest or path of interest based on their geographic location and orientation. Seventh, icons displayed on the touch sensitive system show each camera's position and orientation relative to the environment. Eighth, multiple-users can monitor and manipulate cameras simultaneously.

Embodiments of the current disclosure differ from existing systems in that users do not have to memorize camera names or numbers relative to their location. Users can simply select the region of interest using direct manipulation gestures on a touch sensitive system, and the system will automatically select the cameras closest to the selected region and orient and focus the cameras towards the selected region. This function can be further extended to selecting cameras that are along a path of interest as the operator draws the path using the touch gestures. This eliminates the need for operators to remember the cameras specific to a location and fundamentally changes how operators interact with camera monitoring systems.

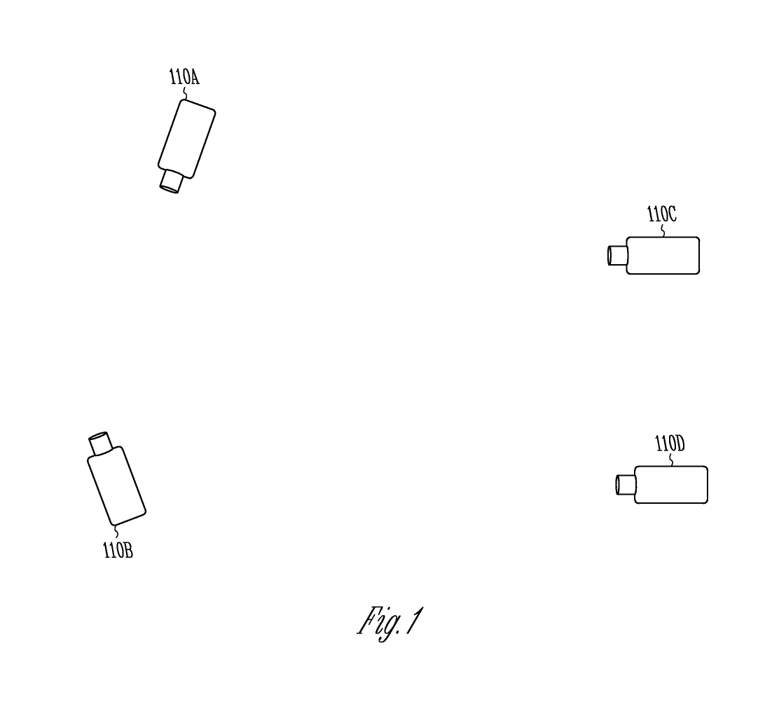

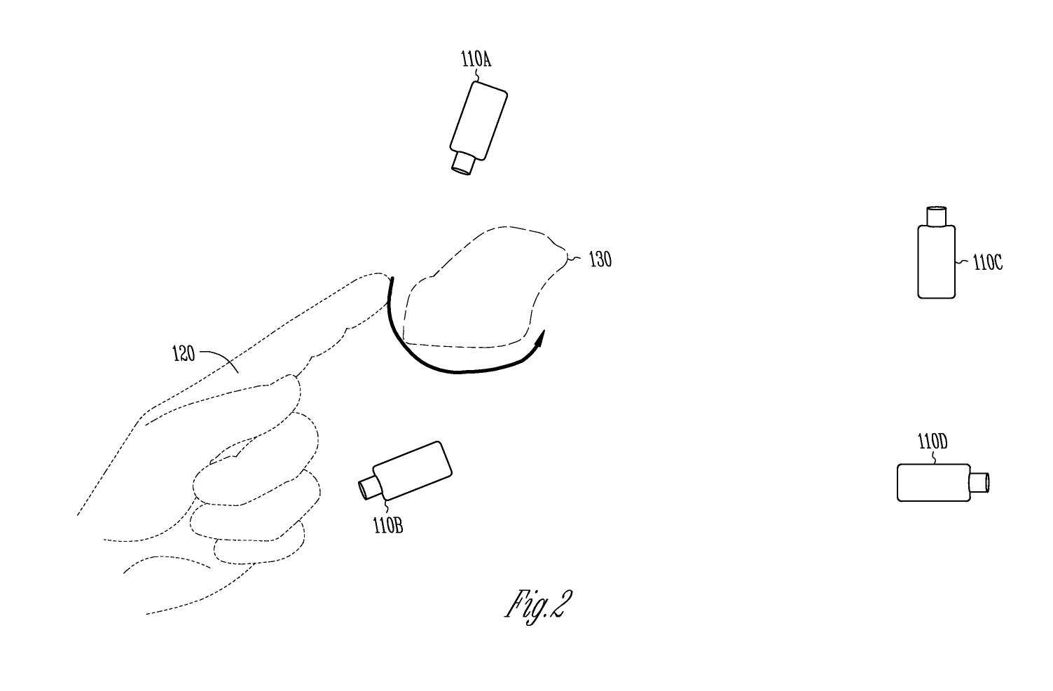

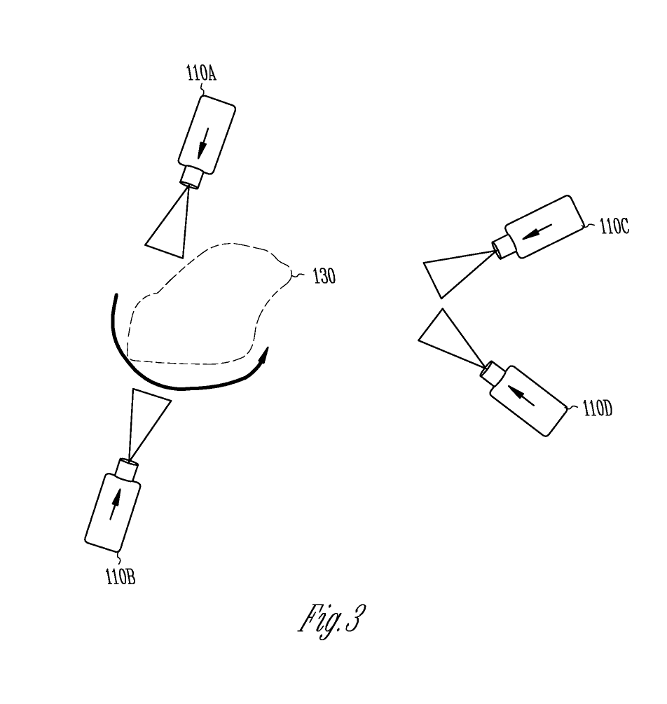

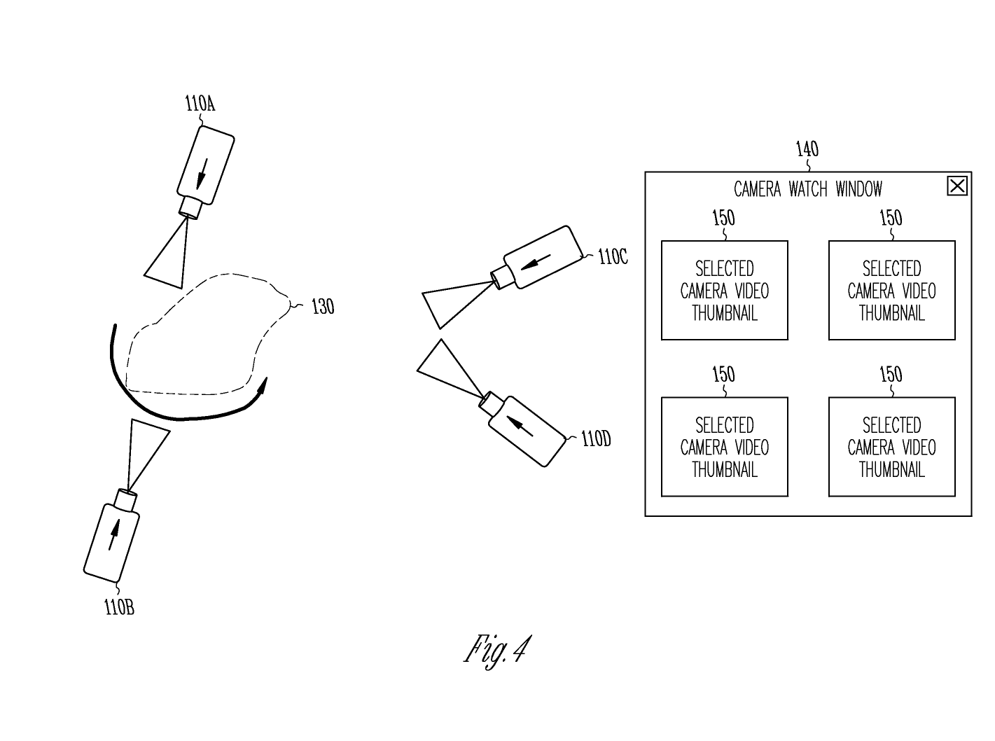

FIGS. 1-6 illustrate output on an embodiment of a system to automatically select cameras via input on a touch screen output display. FIGS. 1-6 illustrate a two dimensional map, but a three dimensional model could also be displayed on the output device. FIGS. 1-6 illustrate a plan view of an area, and of several camera icons 110A, 110B, 110C, and 110D. Each camera icon represents a location and orientation of a real camera in a monitored area, and the re-orientation of the camera icons caused by the input via the touch screen display causes the reorientation of the real cameras in the monitored area. In FIG. 2, an operator 120 identifies a region of interest 130 in the environment. As illustrated in FIG. 2, the operator 120 uses one or more gestures with his or her hand to define a region of interest 130. The operator can define this region of interest 130 simply because that region is of interest, or the operator can be interested in invoking one or more particular cameras by outlining an area in the vicinity of the one or more particular cameras. As illustrated in FIG. 3, the camera icons 110A and 110B that are closest to the selected region 130 automatically orient themselves towards the selected region 130, and the real cameras represented by the camera icons 110A and 110B similarly reorient themselves. Also illustrated in FIG. 3 is that camera icons 110C and 110D that are further from the selected region 130 may also reorient themselves towards the selected region 130. FIG. 4 illustrates a watch window 140 that automatically displays the live camera video feeds as thumbnails 150. The watch window 140 can also display image data that has been recorded on a storage medium.

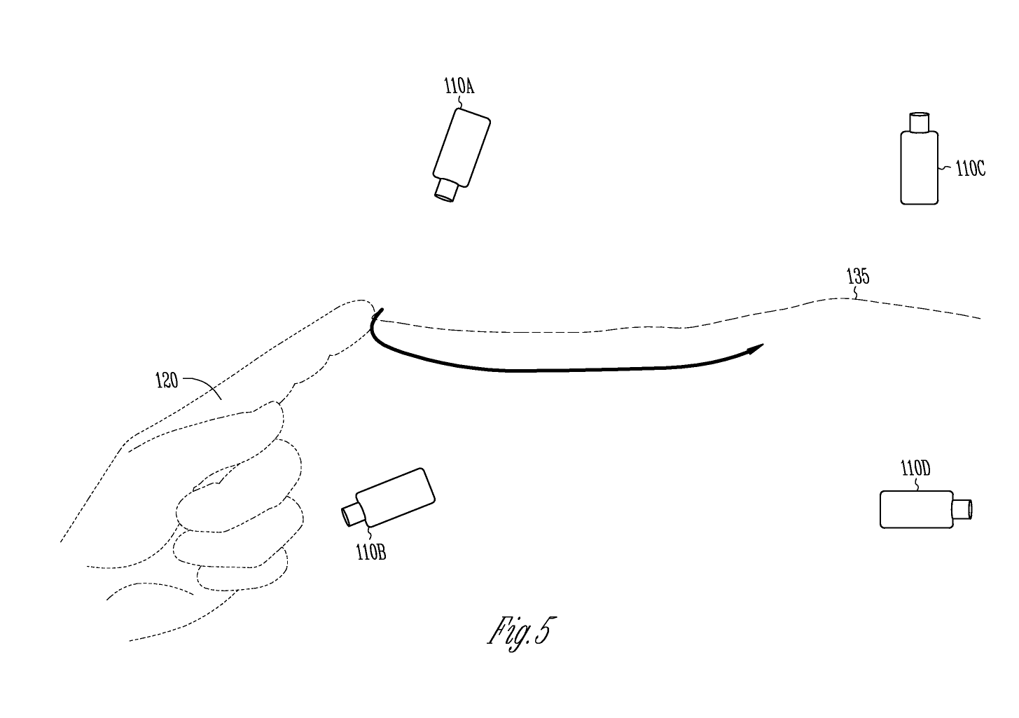

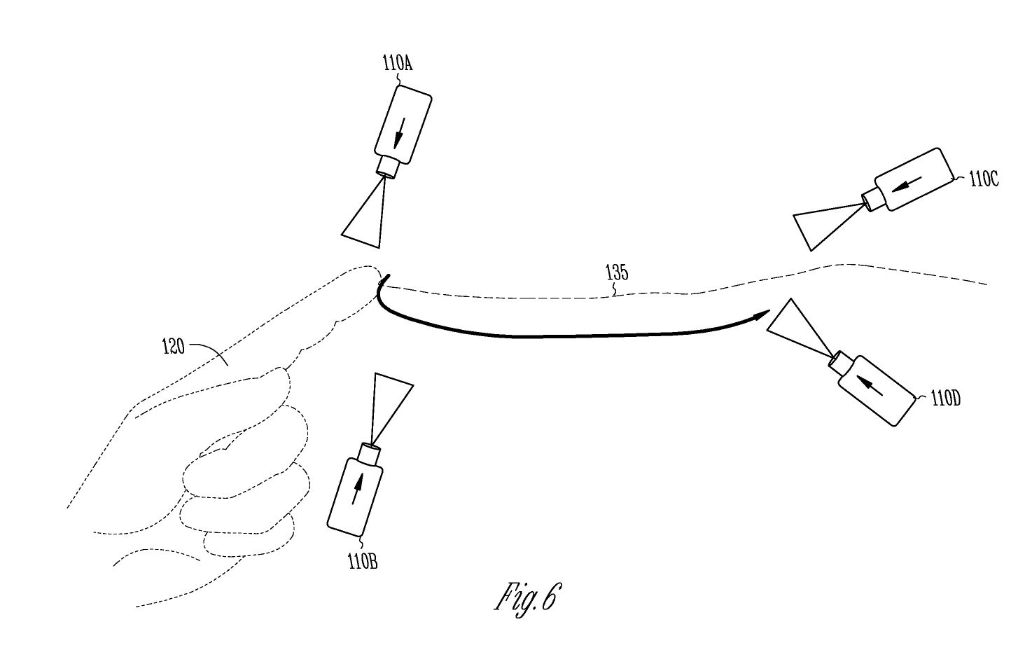

FIG. 5 illustrates an operator 120 defining a path of interest 135. As with defining a region of interest 130, the path of interest 135 can be selected because the operator 120 is interested in that particular path, or because the operator is interested in the live feed on, or data recorded by, a particular camera in the vicinity of that path for one reason or another (e.g., to see if the camera is functioning). FIG. 6 illustrates the cameras 110 reorienting themselves towards the path 135 that was selected by the operator 120 in FIG. 5. While not illustrated, once a path is selected by an operator 120, a watch window with live video feeds can be displayed as was illustrated in FIG. 4 in connection with the selected region 130. The thumbnails displayed in connection with the path 135 can be shown in a sequence based on the path specified from the starting point of the path to the ending point of the path.

Predefined paths or regions can be available and/or saved for later retrieval. This feature can be important for supporting known activities such as monitoring movements inside a facility (e.g., guards/inmates at a prison, cash drops at a casino, and parking lots at a commercial building). There are no limitations on the length of the path 135 or size of the region 130 as long as the gesture is made within the display size boundaries of the touch sensitive system and/or environment boundaries.

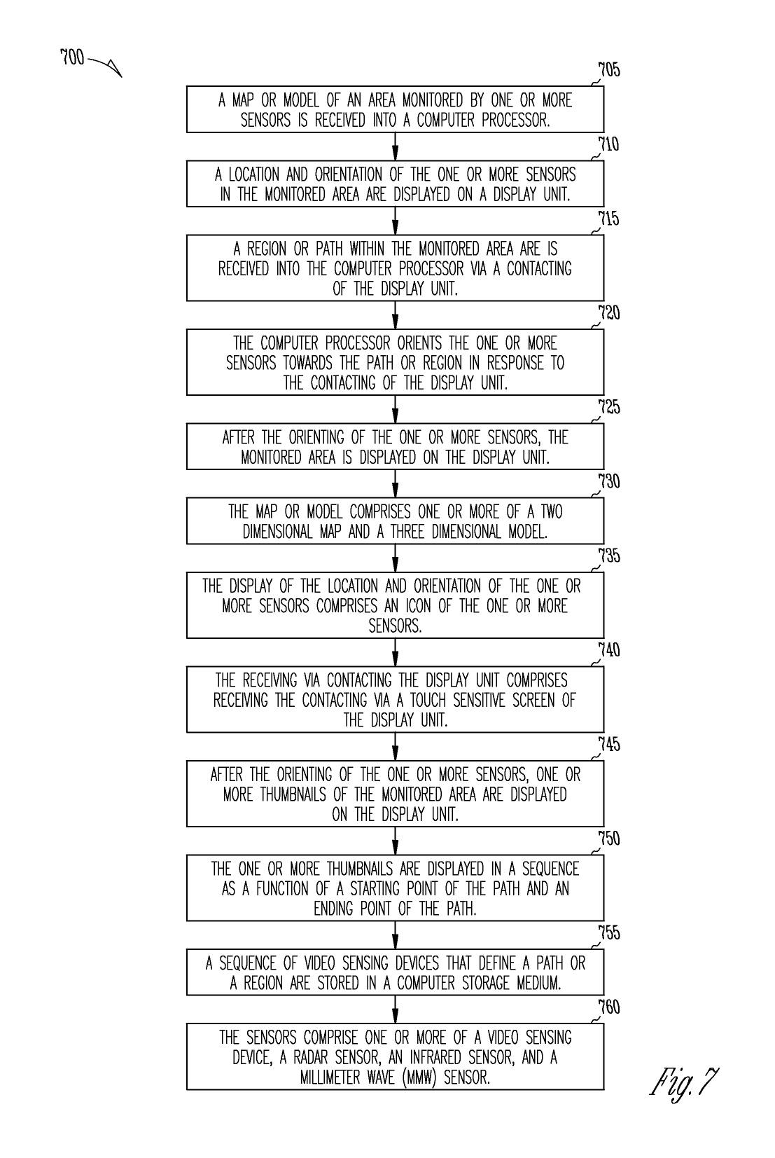

FIG. 7 is a flowchart of an example process 700 for using gestures to automatically select cameras or other sensor devices. FIG. 7 includes a number of process blocks 705-760. Though arranged serially in the example of FIG. 7, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

At 705, a map or model of an area monitored by one or more sensors is received into a computer processor. At 710, a location and orientation of the one or more sensors in the monitored area are displayed on a display unit. At 715, a region or path within the monitored area is received into the computer processor via a contacting of the display unit. At 720, the computer processor orients the one or more sensors towards the path or region in response to the contacting of the display unit, and at 725, after the orienting of the one or more sensors, the monitored area is displayed on the display unit.

At 730, the map or model comprises one or more of a two dimensional map and a three dimensional model. At 735, the display of the location and orientation of the one or more sensors comprises an icon of the one or more sensors. At 740, the receiving via contacting the display unit comprises receiving the contacting via a touch sensitive screen of the display unit. At 745, after the orienting of the one or more sensors, one or more thumbnails of the monitored area are displayed on the display unit. At 750, the one or more thumbnails are displayed in a sequence as a function of a starting point of the path and an ending point of the path. At 755, a sequence of video sensing devices that define a path or a region are stored in a computer storage medium. At 760, the sensors comprise one or more of a video sensing device, a radar sensor, an infrared sensor, and a millimeter wave (MMW) sensor.

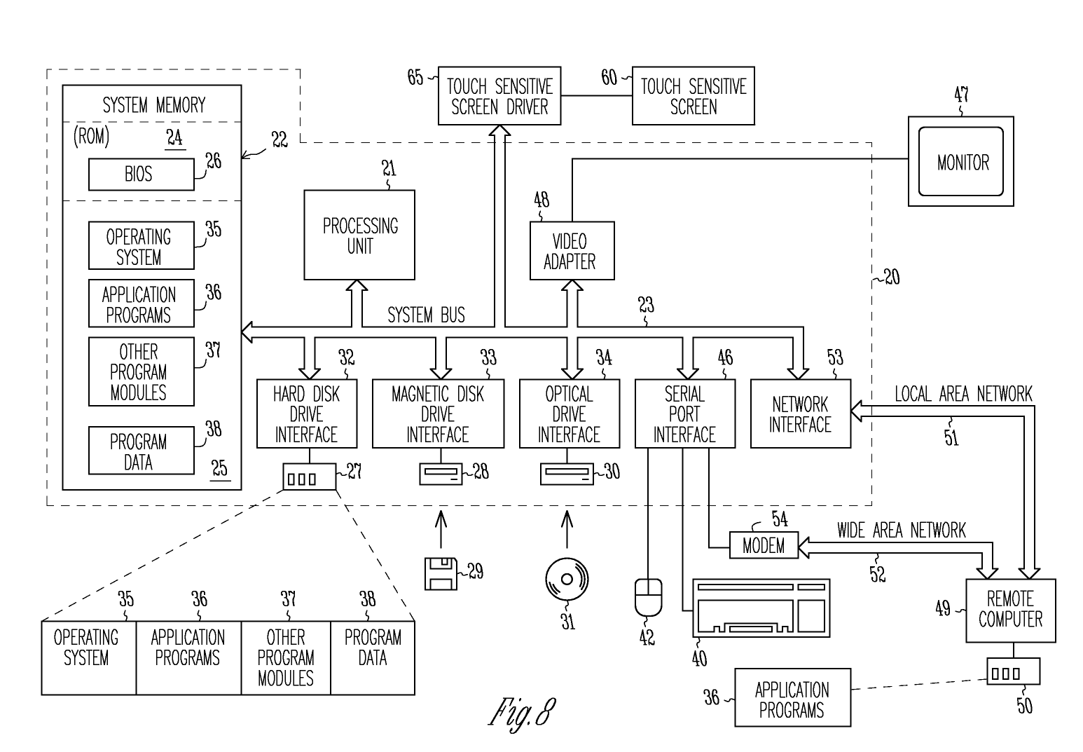

FIG. 8 is an overview diagram of a hardware and operating environment in conjunction with which embodiments of the invention may be practiced. The description of FIG. 8 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 8, a hardware and operating environment is provided that is applicable to any of the servers and/or remote clients shown in the other Figures.

As shown in FIG. 8, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above 110 relative to the computer 20, although only a memory storage device 50 has been illustrated. The logical connections depicted in FIG. 8 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

A touch sensitive screen 60 and a touch sensitive screen driver 65 are coupled to the processing unit 21 via the system bus 23.

### EXAMPLE EMBODIMENTS

In Example No. 1, a system includes a display unit coupled to a computer processor and configured to display a map or model of an area monitored by one or more sensors and to display a location and orientation of the one or more sensors in the monitored area; a computer processor configured to receive, via contacting the display unit, a region or path within the monitored area; a computer processor configured to orient the one or more sensors towards the path or region in response to the contacting of the display unit; and a computer processor configured to display the monitored area on the display unit after the orienting of the one or more sensors.

In Example No. 2, a system includes the features of Example No. 1, and optionally includes a processor configured to display, after the orienting, one or more thumbnails of the monitored area; and a computer processor configured to receive the map or model of the area monitored by the one or more sensors.

In Example No. 3, a system includes the features of Example Nos. 1-2, and optionally includes a processor configured to display the one or more thumbnails in a sequence as a function of a starting point of the path and an ending point of the path.

In Example No. 4, a system includes the features of Example Nos. 1-3, and optionally includes a computer storage medium containing a sequence of video sensing devices that define a path or a region.

In Example No. 5, a system includes the features of Example Nos. 1-4, and optionally includes a system wherein the sensors comprise one or more of a video sensing device, a radar sensor, an infrared sensor, and a millimeter wave (MMW) sensor.

In Example No. 6, a process includes displaying on a display unit a location and orientation of one or more sensors in a monitored area; receiving into a computer processor, via contacting the display unit, a region or path within the monitored area; using the computer processor to orient the one or more sensors towards the path or region in response to the contacting of the display unit; and after the orienting of the one or more sensors, displaying on the display unit the monitored area.

In Example No. 7, a process includes the features of Example No. 6, and optionally includes a process wherein the map or model comprises one or more of a two dimensional map and a three dimensional model.

In Example No. 8, a process includes the features of Example Nos. 6-7, and optionally includes a process wherein the display of the location and orientation of the one or more sensors comprises an icon of the one or more sensors.

In Example No. 9, a process includes the features of Example Nos. 6-8, and optionally includes a process wherein the receiving via contacting the display unit comprises receiving the contacting via a touch sensitive screen of the display unit.

In Example No. 10, a process includes the features of Example Nos. 6-9, and optionally includes displaying after the orienting one or more thumbnails of the monitored area.

In Example No. 11, a process includes the features of Example Nos. 6-10, and optionally includes displaying the one or more thumbnails in a sequence as a function of a starting point of the path and an ending point of the path.

In Example No. 12, a process includes the features of Example Nos. 6-11, and optionally includes receiving into the computer processor one or more of a map or model of the area monitored by one or more sensors; and storing in a computer storage medium a sequence of video sensing devices that define a path or a region.

In Example No. 13, a process includes the features of Example Nos. 6-12, and optionally includes a process wherein the sensors comprise one or more of a video sensing device, a radar sensor, an infrared sensor, and a millimeter wave (MMW) sensor.

In Example No. 14, a process includes the features of Example Nos. 6-13, and optionally includes using the computer processor to orient the one or more sensors on the display unit towards the path or region in response to the contacting of the display unit.

In Example No. 15, a computer readable medium comprising instructions that when executed by a computer processor execute a process comprising displaying on a display unit a location and orientation of one or more sensors in a monitored area; receiving into a computer processor, via contacting the display unit, a region or path within the monitored area; using the computer processor to orient the one or more sensors towards the path or region in response to the contacting of the display unit; and after the orienting of the one or more sensors, displaying on the display unit the monitored area.

In Example No. 16, a computer readable medium includes the features of Example No. 15, and optionally includes instructions for receiving into the computer processor one or more of a map or model of the area monitored by one or more sensors; and instructions for displaying after the orienting one or more thumbnails of the monitored area.

In Example No. 17, a computer readable medium includes the features of Example Nos. 15-16, and optionally includes instructions for displaying the one or more thumbnails in a sequence as a function of a starting point of the path and an ending point of the path.

In Example No. 18, a computer readable medium includes the features of Example Nos. 15-17, and optionally includes instructions for storing in a computer storage medium a sequence of video sensing devices that define a path or a region.

In Example No. 19, a computer readable medium includes the features of Example Nos. 15-18, and optionally includes a computer readable medium wherein the sensors comprise one or more of a video sensing device, a radar sensor, an infrared sensor, and a millimeter wave (MMW) sensor.

In Example No. 20, a computer readable medium includes the features of Example Nos. 15-19, and optionally includes instructions for using the computer processor to orient the one or more sensors on the display unit towards the path or region in response to the contacting of the display unit.

Thus, an example system, method and machine readable medium for automatically orienting sensors have been described. Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a display unit coupled to a computer processor and configured to display a map or model of an area monitored by one or more sensors and to display a location and orientation of the one or more sensors in the monitored area;
a computer processor configured to receive, via contacting the display unit, a region or path within the monitored area;
a computer processor configured to orient the one or more sensors towards the path or region in response to the contacting of the display unit; and
a computer processor configured to display the monitored area on the display unit after the orienting of the one or more sensors.

2. The system of claim 1, comprising a processor configured to display, after the orienting, one or more thumbnails of the monitored area; and a computer processor configured to receive the map or model of the area monitored by the one or more sensors.

3. The system of claim 2, comprising a processor configured to display the one or more thumbnails in a sequence as a function of a starting point of the path and an ending point of the path.

4. The system of claim 1, comprising a computer storage medium containing a sequence of video sensing devices that define a path or a region.

5. The system of claim 1, wherein the sensors comprise one or more of a video sensing device, a radar sensor, an infrared sensor, and a millimeter wave (MMW) sensor.

6. A process comprising:
displaying on a display unit a location and orientation of one or more sensors in a monitored area;
receiving into a computer processor, via contacting the display unit, a region or path within the monitored area;
using the computer processor to orient the one or more sensors towards the path or region in response to the contacting of the display unit; and
after the orienting of the one or more sensors, displaying on the display unit the monitored area.

7. The process of claim 6, wherein the map or model comprises one or more of a two dimensional map and a three dimensional model.

8. The process of claim 6, wherein the display of the location and orientation of the one or more sensors comprises an icon of the one or more sensors.

9. The process of claim 6, wherein the receiving via contacting the display unit comprises receiving the contacting via a touch sensitive screen of the display unit.

10. The process of claim 6, comprising displaying after the orienting one or more thumbnails of the monitored area.

11. The process of claim 10, comprising displaying the one or more thumbnails in a sequence as a function of a starting point of the path and an ending point of the path.

12. The process of claim 6, comprising receiving into the computer processor one or more of a map or model of the area monitored by one or more sensors; and storing in a computer storage medium a sequence of video sensing devices that define a path or a region.

13. The process of claim 6, wherein the sensors comprise one or more of a video sensing device, a radar sensor, an infrared sensor, and a millimeter wave (MMW) sensor.

14. The process of claim 6, comprising using the computer processor to orient the one or more sensors on the display unit towards the path or region in response to the contacting of the display unit.

15. A computer readable medium comprising instructions that when executed by a computer processor execute a process comprising:
displaying on a display unit a location and orientation of one or more sensors in a monitored area;
receiving into a computer processor, via contacting the display unit, a region or path within the monitored area;
using the computer processor to orient the one or more sensors towards the path or region in response to the contacting of the display unit; and
after the orienting of the one or more sensors, displaying on the display unit the monitored area.

16. The computer readable medium of claim 15, comprising instructions for receiving into the computer processor one or more of a map or model of the area monitored by one or more sensors; and instructions for displaying after the orienting one or more thumbnails of the monitored area.

17. The computer readable medium of claim 16, comprising instructions for displaying the one or more thumbnails in a sequence as a function of a starting point of the path and an ending point of the path.

18. The computer readable medium of claim 15, comprising instructions for storing in a computer storage medium a sequence of video sensing devices that define a path or a region.

19. The computer readable medium of claim 15, wherein the sensors comprise one or more of a video sensing device, a radar sensor, an infrared sensor, and a millimeter wave (MMW) sensor.

20. The computer readable medium of claim 15, comprising instructions for using the computer processor to orient the one or more sensors on the display unit towards the path or region in response to the contacting of the display unit.
